(19) United States
(12) Patent Application Publication
(10) Pub. No.: US 2021/0379727 A1
(43) Pub. Date: Dec. 9, 2021

(54) TOOL AND METHOD FOR MECHANICAL SURFACE TREATMENT

(71) Applicant: Schaeffler Technologies AG & Co. KG, Herzogenaurach (DE)

(72) Inventors: André Kuckuk, Gunzenhausen (DE); Martin Buschka, Herzogenaurach (DE)

(73) Assignee: Schaeffler Technologies AG & Co. KG, Herzogenaurach (DE)

(21) Appl. No.: 17/283,064

(22) PCT Filed: Sep. 24, 2019
(86) PCT No.: PCT/DE2019/100838

§ 371 Date: Apr. 6, 2021

(30) Foreign Application Priority Data
Oct. 22, 2018 (DE) 10 2018 126 185.3

(51) Int. Cl. B24B 39/04; B24B 39/02; B23P 9/04

(52) U.S. Cl. CPC B24B 39/04; B23P 9/04; B24B 39/026

(57) ABSTRACT

A tool for mechanical surface treatment includes a housing, a roller body, and a resonator. The housing has a cavity for filling with a hydraulic medium having a basic pressure. The roller body is for rolling on a workpiece surface to be treated and is exposed to the basic pressure of the hydraulic medium. The resonator is arranged for generating targeted pressure pulses in the hydraulic medium. In some example embodiments, the housing has a tubular body with a tip and the roller body is arranged at the tip. In an example embodiment, the roller body is a sphere. In an example embodiment, the tool includes a seal for sealing the roller body to the tubular body.

### CROSS-REFERENCE TO RELATED APPLICATIONS

This application is the United States National Phase of PCT Appln. No. PCT/DE2019/100838 filed Sep. 24, 2019, which claims priority to German Application No. DE102018126185.3 filed Oct. 22, 2018, the entire disclosures of which are incorporated by reference herein.

### TECHNICAL FIELD

The disclosure relates to a tool provided for mechanical surface machining. The disclosure also relates to a mechanical surface machining method.

### BACKGROUND

A generic tool is known, for example, from DE 10 2011 050 662 B4. It is a rolling tool for machining a connecting rod eye. The rolling tool can be rotated as a whole and has a roller body which is inserted into a recess of the rolling tool and, along the recess, is acted upon to the outside by a pressurized fluid. The fluid in the case of DE 10 2011 050 662 B4 is an aerosol.

Another rolling tool is disclosed in DE 103 40 267 A1. This rolling tool has a hydraulically mounted forming roller. The forming roller, which is also referred to as a rolling roller, rotates along a workpiece with a working circumference while the workpiece is being rolled. Here, the scope of work is spatially separated from a bearing contact area of the rolling roller. In particular, the bearing contact area is curved in the shape of a circular arc in cross section, and is arranged on both sides of the workpiece contact area. The rolling tool should be particularly suitable for the machining of components that are exposed to dynamic loads.

Hammering machining of a surface of a workpiece is also categorically known. In this context, reference is made to WO 2016/135169 A1 as an example.

Precision machining with a vibrating head is described in DE 196 34 839 A1. The machining is carried out on a rotating workpiece. A linear motor presses a head of the tool against the rotating workpiece, and at the same time a vibration device is provided for vibrating the head. The fine machining device with a vibrating head is provided for the machining of camshafts.

EP 0 253 907 B1 discloses a method for rolling pins having transverse bores. In the context of this method, a pulsating rolling force is used in part and a non-pulsating rolling force is used in part.

A method for deep rolling crankshafts is described, for example, in DE 30 37 688 C2. The method should be usable in particular at transition radii of bearing pins. Rolling forces occurring during the method pulsate at a frequency of 30 to 300 Hertz.

US 2010/0052262 A1 describes a sealing device provided for a wheel bearing, which includes an elastic sealing element and a metallic stop element. The stop element here has a surface machined by shot blasting treatment.

EP 1 296 801 B1 describes a combined skiving and roller burnishing tool. The tool is intended for the surface machining of the cylindrical interior of a hollow workpiece.

### SUMMARY

The disclosure provides a surface machining tool and a method for mechanical surface machining. The configurations and advantages explained below in connection with the surface machining method also apply analogously to the device, i.e., the tool, and vice versa.

In a basic design known per se, the tool includes a housing in which a cavity provided for filling with a hydraulic medium is formed, as well as at least one roller body exposed to the basic pressure of the hydraulic medium and provided for rolling on a workpiece surface to be machined. According to the disclosure, the tool includes a resonator which is designed to generate targeted pressure pulses in the hydraulic medium. The basic pressure of the hydraulic medium is increased in a targeted, pulsating manner, with the pressure pulses being added to the basic pressure and superimposing it.

The resonator superimposes a pulsating load on the contact pressure of the tool on the workpiece to be machined, leading to a structuring of the surface of the workpiece. The generation of the oscillating load on the roller body through the targeted pulsating application of pressure to the hydraulic medium allows for the forces applied to the workpiece surface by the roller body to be set, controlled and limited in a simple manner.

The resonator used to generate the pressure pulses in the hydraulic medium is, for example, a piezoelectric actuator. For the technological background, reference is made to DE 10 2014 220 883 B4 as an example in this context.

According to a possible embodiment, the surface machining tool has a single roller body, arranged at the tip of the housing. The housing is designed to be tubular as a whole.

The roller body is, for example, a ball. Alternatively, the roller body can be a roller, for example a barrel roller. The roller body can be sealed off from the housing by a seal.

In an examplary space-saving design, the resonator can be built into the housing of the tool. In the interests of forwarding the pressure pulses as undiminishedly as possible, an arrangement of the resonator close to the roller body is advantageous. The resonator can be spatially separated from a device, e.g., a hydraulic pump, for generating the basic pressure in the hydraulic medium, required for the rolling process. For example, a hydraulic pump can be provided as a separate machine, which is not intended to be part of the surface machining tool, but merely to be coupled thereto.

During the rolling of the roller body onto the surface of the workpiece, the contact between the roller body and the workpiece surface is permanently maintained in an example execution of the method. Depending on the geometry of the roller body, it creates, for example, spherical depressions in the workpiece surface due to the pulsating application of pressure. The distribution of the depressions produced on the workpiece surface is typically stochastic or somewhat stochastic.

If the machined surface is a sealing surface of a metallic component, for example a flange, a roller bearing ring, or a plain bearing ring, a favorable relationship between wear resistance, friction of the seal, and sealing effect may be achieved with the surface structuring.

The method for mechanical surface machining includes machining a surface of a rotating metallic workpiece by applying pulsating pressure using a tool according to the disclosure. Pressure pulses or pressure impulses Δp are superimposed on a basic pressure p₀ of the hydraulic medium in a targeted manner.

The frequency of the pulsating pressure application implemented by means of the resonator is, for example, higher than the frequency at which the workpiece to be machined rotates. For example, the pulsating application of pressure may take place at a frequency which corresponds to at least 24 times the rotational speed of the workpiece.

During the pulsating application of pressure, the tool may be displaced linearly with respect to the workpiece. The speed of the linear displacement differs from the surface speed of the roller body on the workpiece, e.g., by a factor of at least 6. This means that the speed at which the tool is displaced relative to the workpiece is either significantly lower or significantly higher than the surface speed of the rotating workpiece.

In the case of a slow advance of the tool, numerous depressions can be produced on a cylindrical workpiece surface, which together describe a helical track. A very even distribution of the depressions on the cylindrical workpiece surface is achieved overall through a high frequency of the pulsating application of pressure and a low pitch of the helical track.

If, on the other hand, the surface to be machined lies in a plane which is aligned normal to the axis of rotation, i.e., the central axis, of the workpiece, the tool can be displaced, for example, radially from the inside to the outside or from the outside to the inside during the machining. If this shift occurs only a single time during the machining process, a trace of depressions is formed, describing a spiral. A uniform distribution of the depressions on the machined surface, for example an end face of a cylindrical component or a front face of a flange, can also be achieved here due to the low speed of the radial displacement and a sufficiently high frequency of the pulsating pressure application.

Disc-shaped surfaces of the type mentioned can also be machined by moving the tool in an oscillating manner between a radially inner and a radially outer extreme point relatively quickly compared to the tangential speed of the surface to be machined. By moving the tool in the radial direction, waves are described on the disk-shaped workpiece surface. In the course of several revolutions of the workpiece, these waves are superimposed so that the result of this method variant is a seemingly stochastic distribution of the depressions on the workpiece surface, which is uniform with good approximation. An analogous method can also be used for a cylindrical workpiece surface. In this case, the tool is moved in the axial direction in an oscillating manner relative to the workpiece. The frequency of this oscillation is higher than the rotational speed of the workpiece.

In all cases, the surface machining tool achieves both consolidation and structuring of the machined surface, and the machining parameters are adjustable within a wide range.

Regardless of the frequency that is ultimately chosen for the rotation of the workpiece to be machined, a number of pressure pulses or pressure impulses Tₘ per distance unit of the rolling path l_{w} may be completed on a surface of a workpiece is in the range from 100 to 5000 per meter.

For example, pressure pulses or pressure impulses Δₚ are applied which are in the range from 0.2*p₀ to 200 bar, where p₀ corresponds to the basic pressure in the hydraulic medium during roller burnishing. Any system-related fluctuations in the basic pressure are negligible since the pressure pulse is added to the current basic pressure.

A use of a tool according to the disclosure for machining a sealing surface of a metallic component, e.g., a flange or a component of a bearing, has proven useful. A surface of the component against which a seal, e.g., an elastic seal made of plastic, comes into contact, is referred to as a sealing surface.

The component of a bearing is, for example, a roller bearing ring, e.g., a wheel bearing, or a sliding bearing ring. For surface structuring of a metallic component in its contact area for a seal, a favorable relationship between wear resistance, friction of the seal, and the sealing effect achieved may be obtained.

### BRIEF DESCRIPTION OF THE DRAWINGS

In the following, an exemplary embodiment of the disclosure is explained in more detail by means of two drawings. In the figures:

FIG. 1 shows a tool for mechanical surface machining in a simplified sectional illustration, and

FIG. 2 shows an illustration of roller burnishing with pulsating pressure in the rolling contact.

### DETAILED DESCRIPTION

A tool 1 for mechanical surface machining has a housing 2 which, in the exemplary embodiment, is designed as a tubular body. The tool 1 is intended for modified roller burnishing and, for the sake of simplicity, is also referred to as a roller burnishing tool. The tool 1 is used to machine a surface of a workpiece that is intended to function as a sealing surface. For example, it can be a sealing surface of a bearing, e.g., a roller or plain bearing, e.g., a wheel bearing. The sealing surface is formed directly on a bearing ring of the bearing, e.g., a roller bearing ring of a wheel bearing.

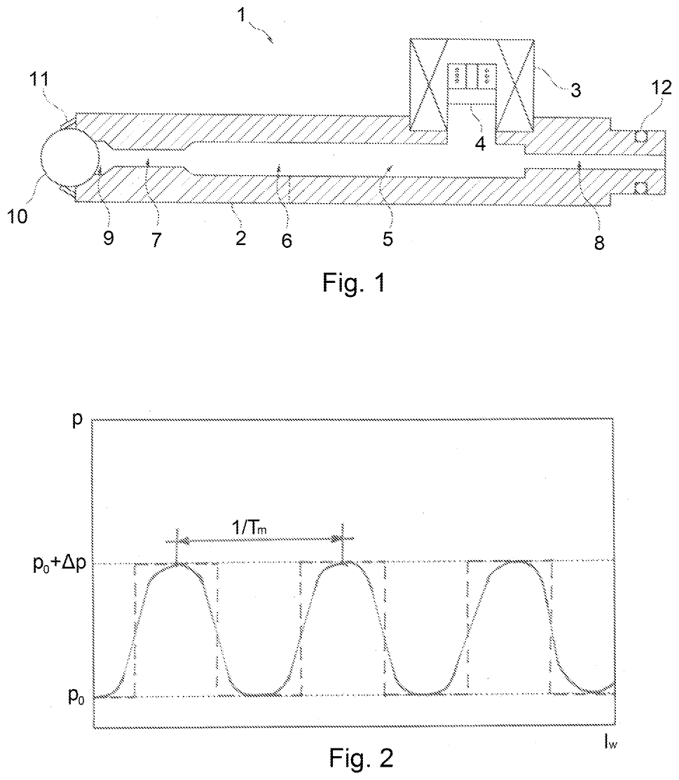

As can be seen from FIG. 1, a resonator 4 is integrated into the housing 2 of the tool 1. The resonator 4 is part of a piezoelectric actuator 3 and adjoins a cavity 5 which extends through the tubular body and is filled with a hydraulic medium. The hydraulic medium is, for example, a hydraulic oil or a cooling lubricant.

The cavity 5 runs through the entire tubular body, with two portions 7, 8 of narrowed cross section adjoining a central portion 6 with an enlarged cross section. An end portion 9 of the cavity 5 at the tip of the tubular body is widened in relation to the portion 7 and extends as far as a machining ball, which is generally referred to as the roller body 10.

The machining ball protrudes from the tubular body and is sealed off therefrom by a seal 11. On the opposite side, i.e., the rear side, of the tubular body, an additional seal 12 can be seen, allowing for the sealed connection of the tool 1 to a pressure medium supply.

A basic pressure p₀ of the hydraulic medium is set in the cavity 5 by the pressure medium supply. A pulsating application of pressure is superimposed on this basic pressure p₀ by the piezoelectric actuator 3, including the resonator 4. The individual pressure pulses or pressure impulses Δₚ ensure that the roller body 10 generates individual depressions in a metallic workpiece surface during the machining process.

During the machining process, in one embodiment of the disclosure, the workpiece is clamped into a machining device, e.g., a lathe. The workpiece surface to be machined typically has a cylindrical shape. The tool 1 is brought up to the workpiece in the radial direction for machining and is displaced in the axial direction during the machining, i.e., in the longitudinal direction of the workpiece central axis. The frequency at which the machining ball pulsates is many times higher than the surface speed of the workpiece. The contact between the roller body 10 and the workpiece surface is permanently maintained during the machining process.

FIG. 2 shows an illustration of roller burnishing with a pulsating pressure profile in the area of the rolling contact between the roller body 10 and a metallic workpiece.

The diagram shows the rolling pressure p plotted against the rolling path l_{w} covered on the surface of the workpiece. The pressure profile of the roller body 10 on the surface of a workpiece to be roller burnished is shown. Starting from the basic pressure p₀ required for roller burnishing, positive pressure pulses or pressure impulses Δₚ are generated, and a maximum pressure p₀+Δp is achieved, which is transmitted to the workpiece to be machined in a pulsating manner. This results in a permanent surface structure on the metallic workpiece with depressions which, in the area of a sealing surface of such a workpiece for example, has the advantages described above with regard to wear resistance, friction of the seal, and the sealing effect achieved.

The pulsating pressure profile does not necessarily have to describe a sinusoidal curve, as shown approximately in FIG. 2, but can also show rising, decreasing, repeating, different and also irregular profiles of the maximum pressure distributed over the surface of the workpiece in the course of the rolling path l_{w}.

### REFERENCE NUMERALS

1 Tool
2 Housing
3 Piezoelectric actuator
4 Resonator
5 Cavity
6 Middle portion
7 Portion
8 Portion
9 End portion
10 Roller body
11 Seal
12 Additional seal
l_{w} Rolling path
p₀ Basic pressure during roller burnishing
Δp Pressure pulse
Tₘ Number or pressure pulses per distance unit

1.-10. (canceled)

11. A tool for mechanical surface treatment comprising:
a housing comprising a cavity for filling with a hydraulic medium with a basic pressure;
a roller body for rolling on a workpiece surface to be treated, the roller body being exposed to the basic pressure of the hydraulic medium; and
a resonator arranged for generating targeted pressure pulses in the hydraulic medium.

12. The tool of claim 11, wherein:
the housing comprises a tubular body with a tip; and
the roller body is arranged at the tip.

13. The tool of claim 12, wherein the roller body is a sphere.

14. The tool of claim 12, further comprising a seal for sealing the roller body to the tubular body.

15. The tool of claim 11, wherein the resonator is built into the housing.

16. The tool of claim 11, wherein the resonator is part of a piezoelectric actuator.

17. A method for mechanical surface treatment, comprising:
providing a rotating metallic workpiece with a surface;
providing the tool of claim 11 for treating the surface with a pulsating pressure;
providing the hydraulic medium with the basic pressure to the tool; and
superimposing pressure pulses of the hydraulic medium on the basic pressure to apply the pulsating pressure in a targeted manner.

18. The method of claim 17, further comprising rotating the rotating metallic workpiece at a rotational speed, wherein a frequency of the pulsating pressure is at least 24 times the rotational speed.

19. The method of claim 18, further comprising linearly displacing the tool relative to the rotating metallic workpiece at a linear displacement speed, wherein the linear displacement speed differs from a surface speed of the roller body on the rotating metallic workpiece by at least a factor of 6.

20. The method of claim 17 wherein the rotating metallic workpiece is a roller bearing ring or sliding bearing ring.
